(19) United States
(12) Patent Application Publication
(10) Pub. No.: US 2018/0286051 A1
(43) Pub. Date: Oct. 4, 2018

(54) ROAD PARAMETER ESTIMATION APPARATUS

(71) Applicant: DENSO CORPORATION, Kariya-city (JP)

(72) Inventors: Shunsuke Suzuki, Kariya-city (JP); Shunya Kumano, Nishio-city (JP); Taiki Kawano, Nishio-city (JP)

(21) Appl. No.: 15/938,507

(22) Filed: Mar. 28, 2018

(30) Foreign Application Priority Data
Mar. 30, 2017 (JP) 2017-067769

(51) Int. Cl. G06T 7/13; G06T 7/60

(52) U.S. Cl. CPC G06T 7/13; G06T 7/60; G06T 2207/20076; G06T 2207/20021; G06T 2207/30256

(57) ABSTRACT

A road parameter estimation apparatus estimates road parameters and includes an image acquiring unit, an edge point extracting unit, an area setting unit, an estimating unit, and a vehicle speed acquiring unit. The image acquiring unit acquires an image that shows an area ahead of the vehicle. The edge point extracting unit extracts edge points in the image. The area setting unit sets an area in the image. The area is a part of the image and having a far-side borderline as a boundary thereof The far-side borderline is a virtual line that is ahead of the vehicle by a distance. The estimating unit estimates road parameters using a Kalman filter based on the edge points. The vehicle speed acquiring unit acquires a vehicle speed. The area setting unit increases the distance from the vehicle to the far-side borderline of the area in the image as the vehicle speed increases.

### CROSS-REFERENCE TO RELATED APPLICATION

This application is based on and claims the benefit of priority from Japanese Patent Application No. 2017-067769, filed Mar. 30, 2017. The entire disclosure of the above application is incorporated herein by reference.

### BACKGROUND

### Technical Field

The present disclosure relates to a road parameter estimation apparatus.

### Related Art

A road parameter estimation apparatus such as the following is conventionally known. In the road parameter estimation apparatus, an image that shows an area ahead of a vehicle is acquired using a camera. Edge points that are present on a lane boundary line in the image are extracted. Based on the extracted edge points, road parameters are estimated using a Kalman filter. For example, a road parameter estimation apparatus such as this is disclosed in JP-A-2002-109695.

In the conventional road parameter estimation apparatus, estimation accuracy regarding road parameters may decrease depending on vehicle speed.

### SUMMARY

It is thus desired to provide a road parameter estimation apparatus that is capable of suppressing reduction in estimation accuracy regarding road parameters.

An exemplary embodiment of the present disclosure provides a road parameter estimation apparatus that estimates road parameters. The road parameter estimation apparatus includes: an image acquiring unit that acquires an image that shows an area ahead of a vehicle; an edge point extracting unit that extracts edge points in the image; an area setting unit that sets an area in the image, the area being a. part of the image and having a far-side borderline as a boundary thereof, the far-side borderline being a virtual line that is ahead of the vehicle by a distance; an estimating unit that estimates the road parameters using a Kalman filter, based on the edge points extracted by the edge point extracting unit and positioned in the area set by the area setting unit; and a vehicle speed acquiring unit that acquires a vehicle speed of the vehicle. The area setting unit increases the distance from the vehicle to the far-side borderline of the area in the image, as the vehicle speed acquired by the vehicle speed acquiring unit increases.

The road parameter estimation apparatus according to the exemplary embodiment increases the distance from the vehicle to the far-side borderline of the area, as the vehicle speed increases. As a result, reduction in estimation accuracy regarding the road parameters can be suppressed even when the vehicle speed changes.

### BRIEF DESCRIPTION OF THE DRAWINGS

In the accompanying drawings:

FIG. 1 is a block diagram of a configuration of an onboard system including a road parameter estimation apparatus according to a first embodiment;

FIG. 2 is a block diagram of a functional configuration of the road parameter estimation apparatus according to the first embodiment;

FIG. 3 is a flowchart of an overall process performed by the road parameter estimation apparatus according to the first embodiment;

FIG. 4 is a flowchart of an area setting process performed by the road parameter estimation apparatus according to the first embodiment;

FIG. 5 is an explanatory diagram of an example of an image according to the first embodiment;

FIG. 6 is an explanatory diagram of an example of a traffic lane, lane boundary lines, edge points, an area, a borderline (far-side borderline), and an in-image position in an image, according to the first embodiment;

FIG. 7 is a bird's eye view of an example of a traffic lane, lane boundary lines, an area, a borderline (far-side borderline), an own vehicle, and distance, according to the first embodiment;

FIG. 8 is an explanatory diagram of an example of a map prescribing a relationship between vehicle speed and distance according to the first embodiment;

FIG. 9 is an explanatory diagram of an example of an image in which a preceding vehicle is present according to the first embodiment;

FIG. 10 is an explanatory diagram of an example of an image in which an area in which edge points are not extracted due to backlight or a blurred lane boundary line is present, according to the first embodiment;

FIG. 11 is graph of estimated results of curvature when the vehicle speed is 60 km/h, according to the first embodiment;

FIG. 12 is a graph of the estimated results of curvature when the vehicle speed is 80 km/h, according to the first embodiment;

FIG. 13 is a graph of the estimated results of curvature when the vehicle speed is 100 km/h, according to the first embodiment; and

FIG. 14 is a graph of the estimated results of curvature when the vehicle speed is 120 km/h, according to the first embodiment.

### DESCRIPTION OF THE EMBODIMENTS

Embodiments of the present disclosure will be described with reference to the drawings.

### First Embodiment

### 1. Configuration of a Road Parameter Estimation Apparatus

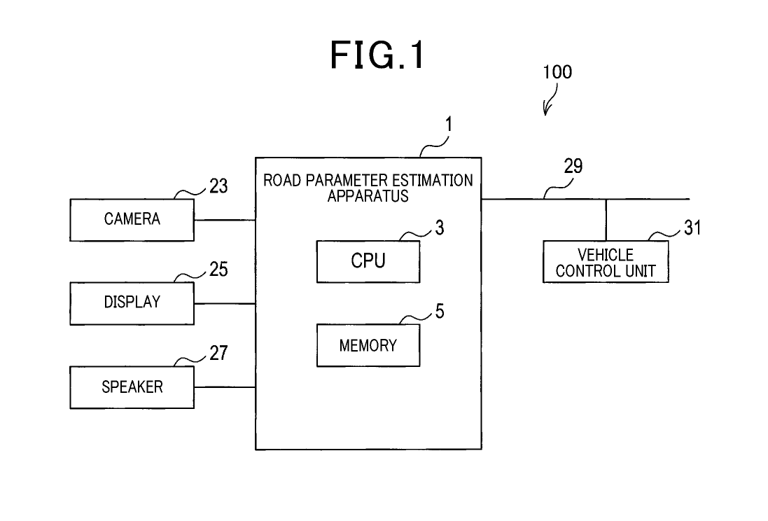

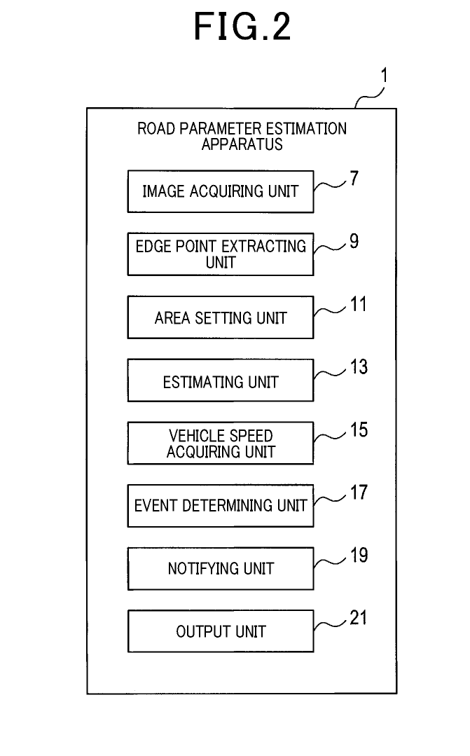

A configuration of a road parameter estimation apparatus 1 according to a first embodiment will be described with reference to FIGS. 1 and 2. The road parameter estimation apparatus 1 is an onboard apparatus that is mounted to a vehicle. The vehicle to which the road parameter estimation apparatus 1 is mounted will be referred to hereafter as an own vehicle.

The road parameter estimation apparatus 1 is mainly configured by a known microcomputer that includes a central processing unit (CPU) 3 and a semiconductor memory (referred to, hereafter, as a memory 5), such as a random access memory (RAM), a read-only memory (ROM), or a flash memory. Various functions of the road parameter estimation apparatus 1 are actualized as a result of the CPU 3 running a program stored in a non-transitory computer readable storage medium. In this example, the memory 5 corresponds to the non-transitory computer readable storage medium in Which the program is stored. In addition, a method corresponding to the program is performed as a result of the program being run. The road parameter estimation apparatus 1 may be configured by a single or a plurality of microcomputers.

Content stored in the memory 5 includes a Kalman filter and a model that are used in a process described hereafter. In addition, the content stored in the memory 5 includes a height of a camera 23, described hereafter, from a road surface, a focal length of the camera 23, and a position of a point at infinity in an image acquired by the camera 23.

As shown in FIG. 2, as a configuration of functions that are actualized as a result of the CPU 3 running the program, the road parameter estimation apparatus 1 includes an image acquiring unit 7, an edge point extracting unit 9, an area setting unit 11, an estimating unit 13, a vehicle speed acquiring unit 15. an event determining unit 17, a notifying unit 19, and an output unit 21. The means by which the elements configuring the road parameter estimation apparatus I are actualized is not limited to software. Some or all of the elements may be actualized through use of a single or a plurality of pieces of hardware. For example, in cases in which the above-described functions are actualized by an electronic circuit, which is hardware, the electronic circuit may be actualized by either of a digital circuit that includes numerous logic circuits, an analog circuit, or both.

As shown in FIG. 1, the own vehicle includes, in addition to the road parameter estimation apparatus 1, the camera 23, a display 25, a speaker 27, an onboard network 29, and a vehicle control unit 31 that configure an onboard system 100.

The camera 23 captures an image of an area ahead of the own vehicle and generates an image. An angle of view of the image includes a scene ahead of the own vehicle. The scene ahead of the own vehicle includes lane boundary lines. For example, the lane boundary line is a white line or Bott's dots.

The display 25 is provided in a vehicle cabin of the own vehicle. The display 25 is capable of displaying an image based on a command from the road parameter estimation apparatus 1. The speaker 27 is provided in the vehicle cabin of the own vehicle. The speaker 27 is capable of outputting audio based on a command from the road parameter estimation apparatus 1.

The road parameter estimation apparatus 1 is connected to the vehicle control unit 31 and the like by the onboard network 29. The road parameter estimation apparatus 1 can acquire vehicle information, such as a vehicle speed and a yaw rate of the own vehicle, through the onboard network 29.

The vehicle control unit 31 acquires road parameters from the road parameter estimation apparatus 1 through the onboard network 29. The vehicle control unit 31 performs publicly known driving assistance using the road parameters. For example, driving assistance includes lane-keeping assist.

### 2. Process Performed by the Road Parameter Estimation Apparatus

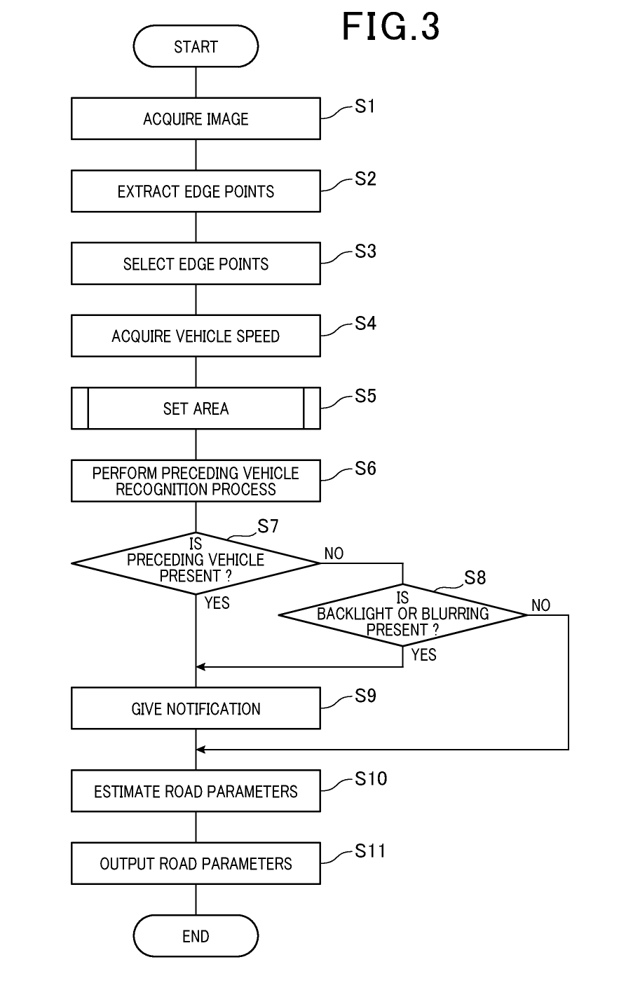

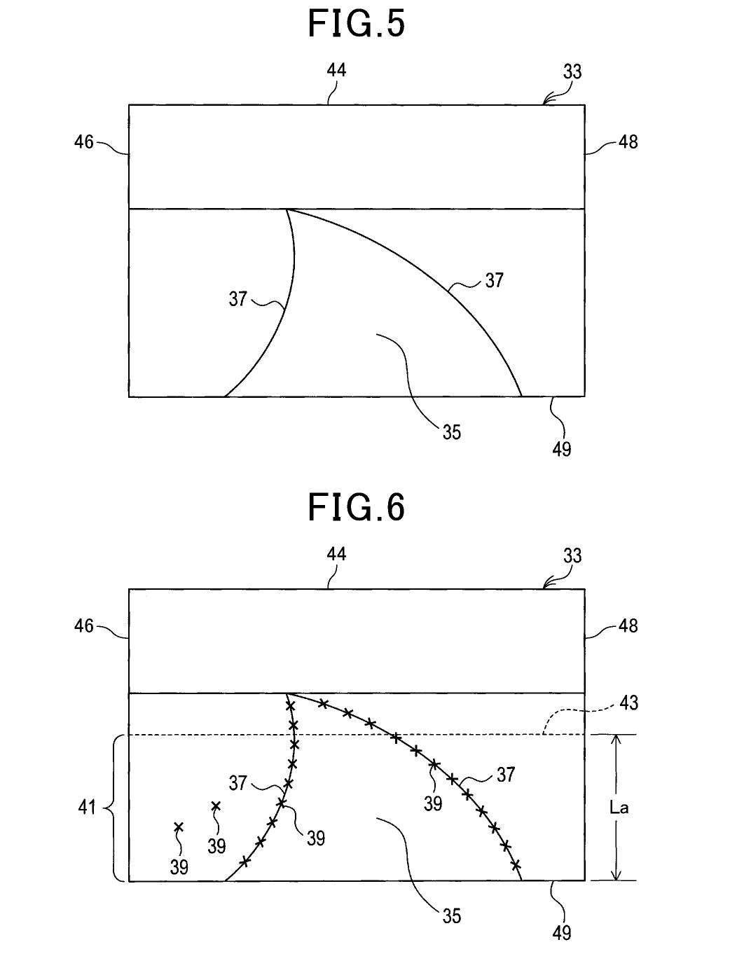

A process performed by the road parameter estimation apparatus 1 will be described with reference to FIGS. 3 to 10. At step S1 in FIG. 3, the image acquiring unit 7 acquires an image using the camera 23. FIG. 5 shows an example of an image 33 that is acquired and has an upper side 44, a lower side 49, a left side 46, and a right side 48. The image 33 shows an area ahead of the own vehicle. The image 33 includes a traffic lane 35 in which the own vehicle is traveling, and lane boundary lines 37 that demarcate the traffic lane 35.

At step S2, the edge point extracting unit 9 extracts edge points in the image acquired at step S1. The edge point is a pixel of which luminance abruptly changes compared to surrounding pixels. FIG. 6 shows an example of extracted edge points 39. The edge points 39 are mainly positioned on the lane boundary lines 37. In addition, edge points 39 attributed to noise that are present in positions away from the lane boundary lines 37 may also be present.

At step S3, the edge point extracting unit 9 selects the edge points 39 that are highly likely to be positioned on the lane boundary lines 37, among the edge points 39 extracted at step S2. For example, the edge point extracting unit 9 can calculate a straight line using the Hough transform based on the edge points 39 extracted at step S2, and select the edge points 39 near the straight line. In addition, the edge point extracting unit 9 can set an area in which the lane boundary lines are currently highly likely to be present based on road parameters that have been estimated in the past, and select the edge points 39 that are present in the area.

At step S4, the vehicle speed acquiring unit 15 acquires a current vehicle speed of the own vehicle through the onboard network 29.

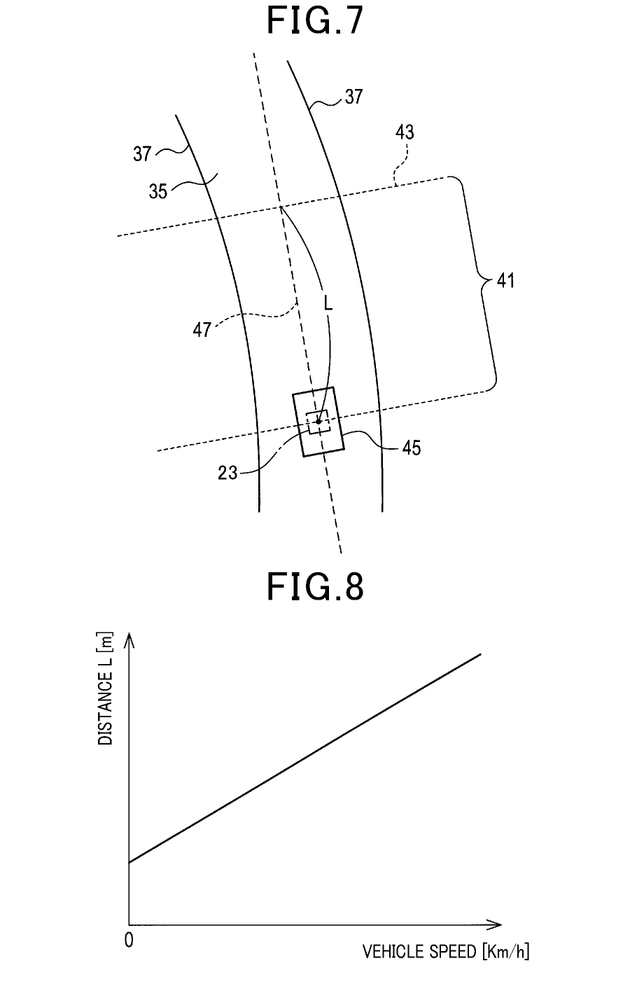

At step S5. the area setting unit 11 sets an area 41 within the image acquired at step S1. As shown in FIG. 6, the area 41 is a part of the image 33 below a borderline 43. As shown in FIG. 7, the borderline 43 is a virtual line that is ahead of the own vehicle 45 (i.e, the camera 23) by a distance L and orthogonal to a front-rear direction 47 of the own vehicle 45. In FIG. 7, the area 41 from the own vehicle 45 to the borderline 43 corresponds to the area 41 in FIG. 6. The borderline 43 is a far-side borderline of the area 41.

In the present embodiment, the area 41 is rectangular and has an upper side borderline, a lower side borderline, a left side borderline, and a right side border line. The upper side borderline of the area 41 corresponds to the border line 43, i.e., the far-side borderline of the area 41. The lower side borderline of the area 41 corresponds to the lower side 49 of the image 33. The left side borderline of the area 41 corresponds to the left side 46 of the image 33. The right side borderline of the area 41 corresponds to the right side 48 of the image 33.

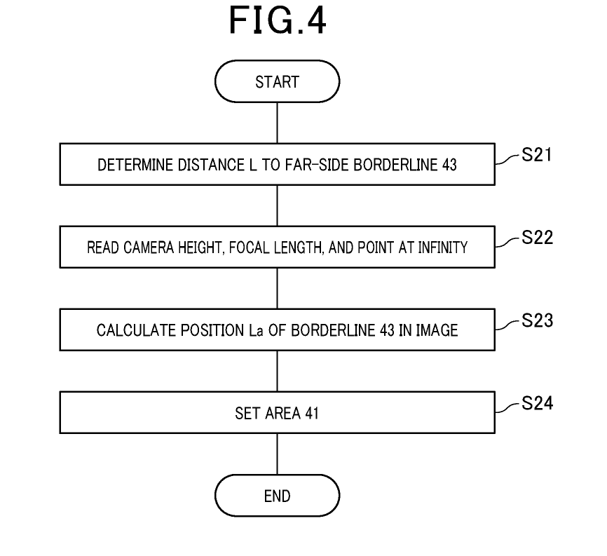

A specific method for setting the area 41 will be described with reference to FIGS. 4 and 8. At step S12 in FIG. 4, the area setting unit 11 applies the vehicle speed acquired at step S4 to a map shown in FIG. 8, and thereby determines the distance L. The map prescribes a relationship between the vehicle speed and the distance L. In this map, the distance L is proportional to the vehicle speed. In this map, the distance L increases as the vehicle speed increases. The map is stored in the memory 5 in advance.

At step S22, the area setting unit 11 reads out the height of the camera 23 from the road surface, the focal length of the camera 23, and the position of the point at infinity in the image 33, from the memory 5.

At step S23, the area setting unit 11 calculates a position in the image 33 (referred to hereafter as an in-image position La) of the borderline that is separated from the own vehicle by the distance L determined at step S21, using the information read at step S22. The in-image position La is a distance in an up-down direction from the lower side 49 of the image 33. FIG. 6 shows an example of the in-image position La.

As shown in FIG. 6, at step S24, the area setting unit 11 sets an area of the image 33 below the borderline 43 of which the position La in the image has been calculated at step S23, as the area 41.

Returning to FIG. 3, at step S6, the event determining unit 17 performs a process to recognize a leading vehicle in the image 33 acquired at step S1, by a publicly known pattern recognition method. The preceding vehicle corresponds to an event (condition) that makes extraction of the edge points 39 difficult.

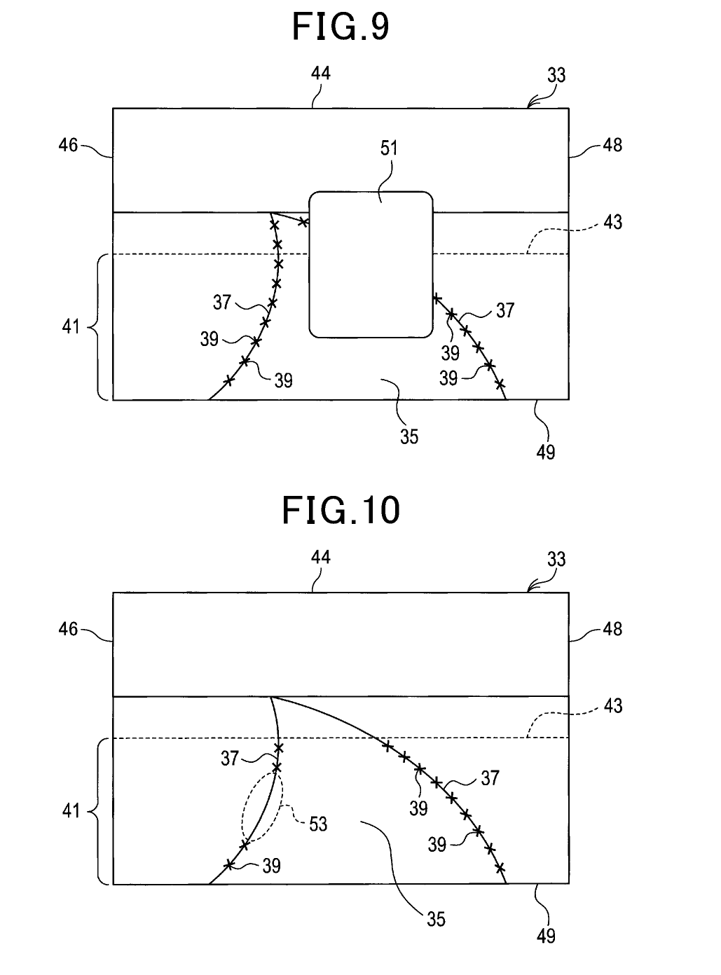

At step S7, the event determining unit 17 determines whether or not a preceding vehicle that overlaps the area 41 set at step S5 is recognized in the process at step S6. When determined that such a preceding vehicle is recognized, the event determining unit 17 proceeds to step S9. When determined that such a preceding vehicle is not recognized, the event determining unit 17 proceeds to step S8. FIG. 9 shows an example of a case in which a preceding vehicle 51 that overlaps the area 41 is recognized. At step S7, the event determining unit 17 makes an affirmative determination both when the overall preceding vehicle 51 overlaps the area 41 and when a portion of the preceding vehicle 51 overlaps the area 41.

At step S8, the event determining unit 17 determines whether or not backlight or a blurred lane boundary line is present in the area 41 set at step S5. The backlight and the blurred lane boundary line correspond to events that make extraction of the edge points 39 difficult.

As shown in FIG. 10, the event determining unit 17 determines that backlight or a blurred lane boundary line is present when an area 53 in which the edge points 39 are not extracted is present in a position that is highly likely to be on a lane boundary line, and the size of the area 53 is a predetermined threshold or greater. The event determining unit 17 then proceeds to step S9. When determined that the area 53 is not present or the size of the area 53 is less than the threshold, the event determining unit 17 determines that neither backlight nor a blurred lane boundary line is present and proceeds to step S10.

At step S9, the notifying unit 9 gives notification using the display 25 and the speaker 27. In addition, the notifying unit 9 outputs a signal to the vehicle control unit 31 indicating that the estimation accuracy regarding road parameters has decreased. The vehicle control unit 31 performs processes to suppress erroneous operations in driving assistance based on the signal.

At step S10, the estimating unit 13 estimates the road parameters using the Kalman filter, based on the edge points 39 that have been selected at step S3 and are positioned within the area 41 set at step S5. The estimating unit 13 does not use edge points 39 positioned outside of the area 41 to estimate the road parameter, even should the edge point 39 be selected at step S3.

The estimated road parameters are a position of a lane boundary line, a tilt of the lane boundary line in relation to the front-rear direction of the own vehicle, a curvature of the lane boundary line, a lane width, a rate of change of the curvature, and an amount of pitch.

Among the estimated road parameters, the curvature of the lane boundary line and the rate of change thereof are values at a position that the own vehicle will reach in 0.7 seconds. Other road parameters are values at the current position of the own vehicle.

At step S11, the output unit 21 outputs the road parameters estimated at step S10 to the vehicle control unit 31.

### 3. Effects Achieved by the Road Parameter Estimation Apparatus

(1A) The road parameter estimation apparatus 1 increases the distance L as the vehicle speed of the own vehicle increases. As a result, even when the vehicle speed of the own vehicle changes, reduction in the estimation accuracy regarding road parameters can be suppressed. A reason for this suppression in the reduction in the estimation accuracy regarding road parameters is thought to be that, as a result of the distance L increasing as the vehicle speed of the own vehicle increases, delays in response and overshooting regarding the calculated road parameters can be suppressed.

(1B) The road parameter estimation apparatus 1 increases the distance L in proportion to the vehicle speed of the own vehicle. Therefore, reduction in the estimation accuracy regarding road parameters can be further suppressed. In addition, calculation of the distance L is facilitated.

(1C) The road parameter estimation apparatus 1 gives notification when an event that makes extraction of the edge points 39 difficult is determined to be present in at least a part of the area 41. As a result, erroneous operation of the vehicle control unit 31 attributed to inaccurate road parameters can be suppressed.

(1D) The road parameter estimation apparatus 1 gives notification when any event among a preceding vehicle, backlight, and a blurred lane boundary line is present. As a result, erroneous operation of the vehicle control unit 31 attributed to inaccurate road parameters can be suppressed.

(1E) The road parameter estimation apparatus 1 can estimate the position of the lane boundary line, the tilt of the lane boundary line in relation to the front-rear direction of the own vehicle, the curvature of the lane boundary line, the lane width, the rate of change of the curvature, and the amount of pitch.

### 4. Test to Confirm Effects Achieved by the Road Parameter Estimation Apparatus

A test was conducted to confirm the effects achieved by the road parameter estimation apparatus 1. The own vehicle was driven on a road (referred to, hereafter, as a test road) that includes a first straight segment, a curved segment that follows the first straight segment and has a radius of curvature of 500 m, and a second straight segment that follows the curved segment. The vehicle speeds at which the own vehicle travels the test road were 60 km/h, 80 km/h, 100 km/h, and 120 km/h.

The road parameter estimation device 1 repeatedly estimated the curvature while the own vehicle traveled the test road. At this time, the distance L was increased as the vehicle speed increased. Specifically, the distance L was set to 35 m when the vehicle speed was 60 km/h. The distance L was set to 45 m when the vehicle speed was 80 km/h. The distance L was set to 55 in when the vehicle speed was 100 km/h. The distance L was set to 75 m when the vehicle speed was 120 km/h.

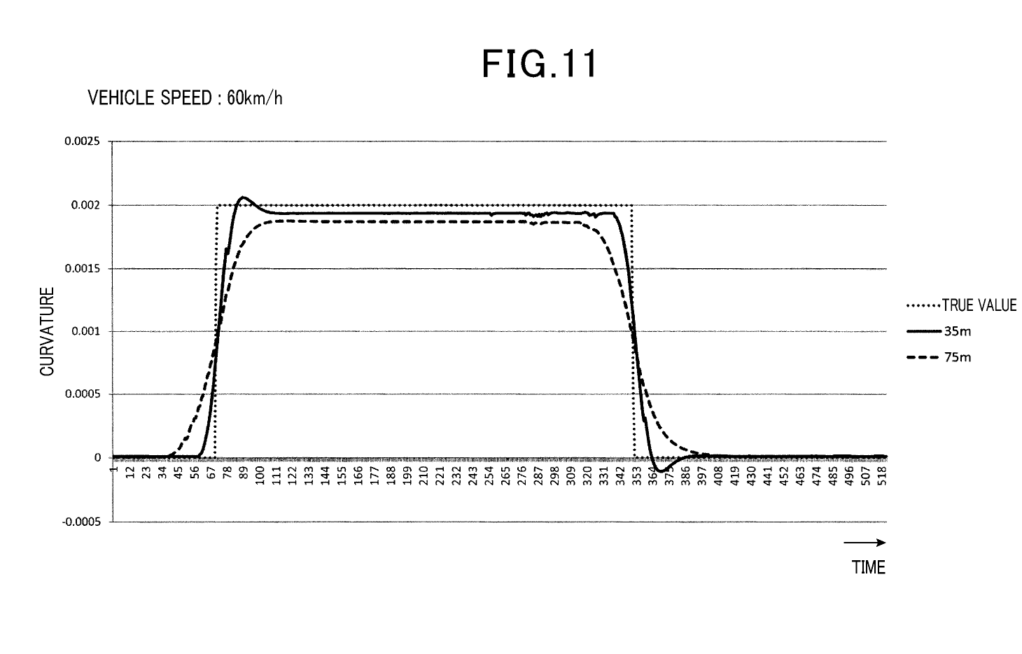

FIGS. 11 to 14 show the curvatures that were estimated when the distance L was set as described above based on the vehicle speed. In FIGS. 11 to 14, a horizontal axis indicates time and a vertical axis indicates curvature. FIGS. 11 to 14 also indicates true values of the curvature. The curvature estimated by the road parameter estimation apparatus 1 is close to the true value for all of the vehicle speeds.

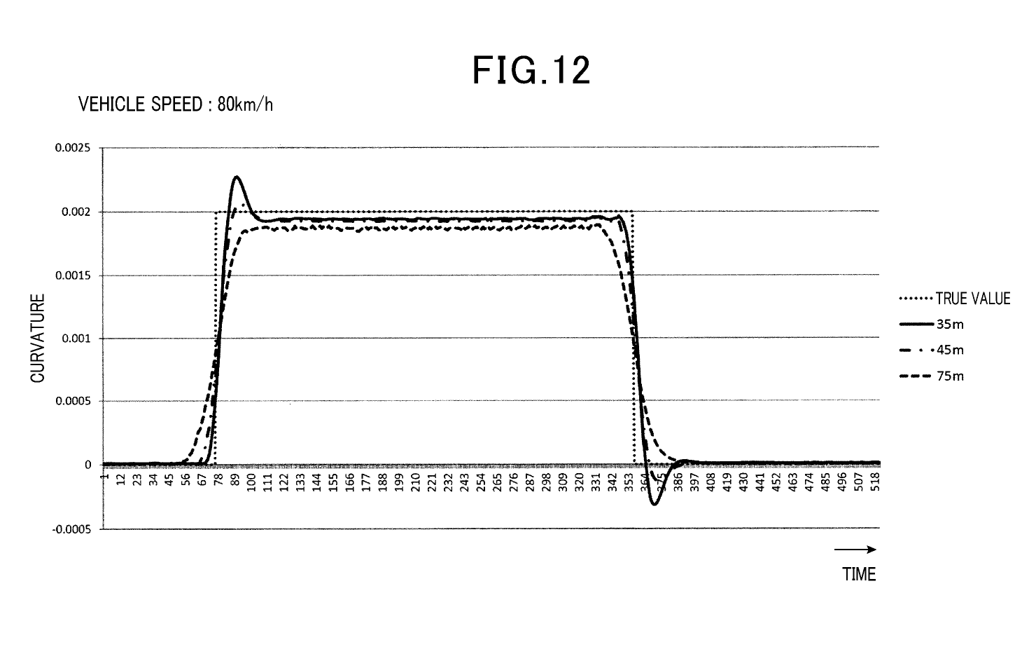

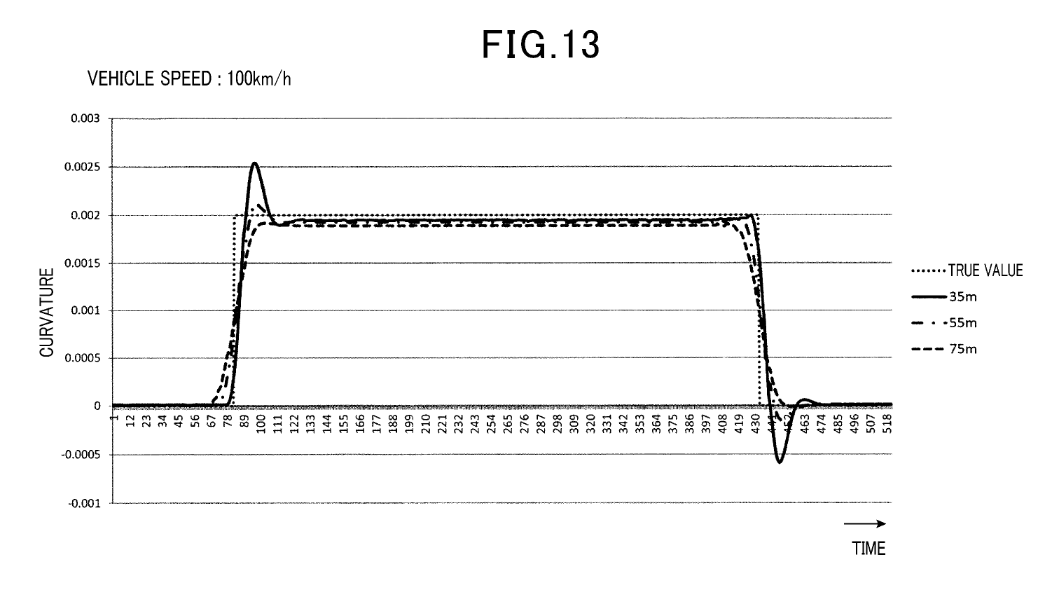

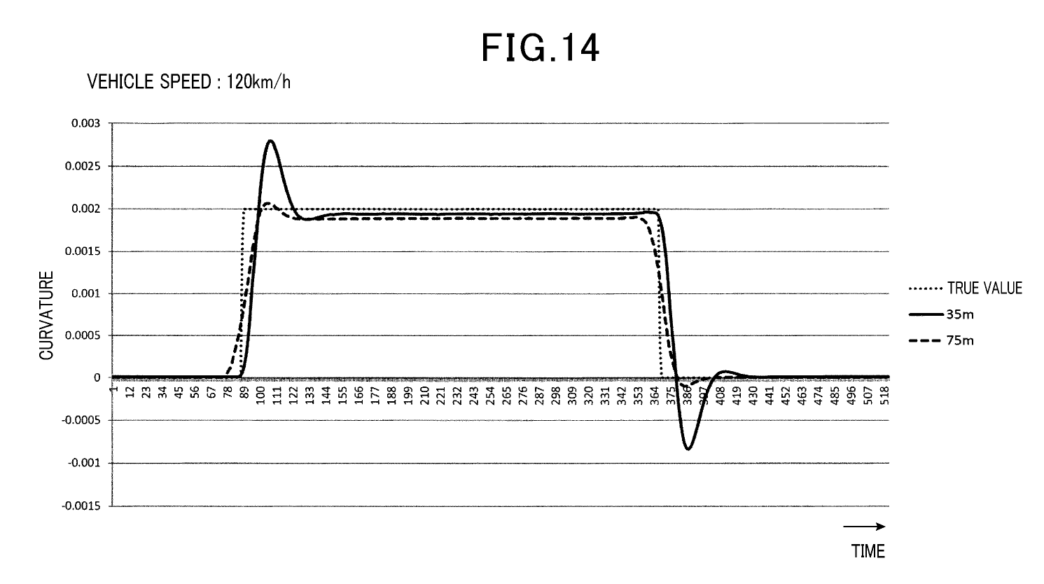

As a reference example, FIG. 11 shows a curvature estimated when the vehicle speed is 60 km/h and the distance L set to 75 m. FIG. 12 shows a curvature estimated when the vehicle speed is 80 km/h and the distance L is set to 35 m or 75 m. FIG. 13 shows a curvature estimated when the vehicle speed is 100 km/h and the distance L is set to 35 m or 75 m. FIG. 14 shows a curvature estimated when the vehicle speed is 120 km/h and the distance L is set to 35 m.

As shown in FIGS. 11 to 14, should the distance L be set to 35 m at all times regardless of vehicle speed, the estimated curvature significantly deviates from the true value as the vehicle speed increases. In addition, should the distance L be set to 75 m at all times regardless of vehicle speed, the estimated curvature significantly deviates from the true value as the vehicle speed decreases.

### Other Embodiments

An embodiment of the present disclosure is described above. However, the present disclosure is not limited to the above-described embodiment. Various modifications are possible.

(1) The road parameter estimation apparatus 1 may estimate parameters other than those described above as the road parameter.

(2) The area 41 may be an area in which a portion has been omitted from the area shown in FIG. 6. For example, the borderline on the lower side of the area 41 may be above the lower side 49 of the image 33. In addition, the width of the area 41 may be narrower than the width of the image 33. In addition, the area 41 may be a shape other than a rectangle. For example, the area 41 may be a trapezoid, a triangle, a circle, or an ellipse.

(3) The relationship between the vehicle speed and the distance L may be other than that shown in FIG. 8. For example, the relationship may be that indicated by a curved line or a stepped line in FIG. 8.

(4) At steps S7 and S8, whether or not an event other than a preceding vehicle, backlight, and a blurred lane boundary line that makes extraction of the edge points 39 difficult is present may be determined.

(5) A plurality of functions provided by a single constituent element according to the above-described embodiments may be actualized by a plurality of constituent elements. A single function provided by a single constituent element may be actualized by a plurality of constituent elements. In addition, a plurality of functions provided by a plurality of constituent elements may be actualized by a single constituent element. A single function provided by a plurality of constituent elements may be actualized by a single constituent element. Furthermore, a part of a configuration according to the above-described embodiments may be omitted. Moreover, at least a part of a configuration according to an above-described embodiment may be added to or replace a configuration according to another of the above-described embodiments. Any embodiment included in the technical concept specified solely by the wordings of the scope of claims is an embodiment of the present disclosure.

(6) The present disclosure can also be actualized by various modes in addition to the above-described road parameter estimation apparatus, such as a system of which the road parameter estimation apparatus is a constituent element, a program enabling a computer to function as the road parameter estimation apparatus, a non-transitory computer readable storage medium such as a semiconductor memory on which the program is recorded, a road parameter estimation method, and a driving assistance method.

What is claimed is:

1. A road parameter estimation apparatus that estimates road parameters, comprising:
an image acquiring unit that acquires an image that shows an area ahead of a vehicle;
an edge point extracting unit that extracts edge points in the image;
an area setting unit that sets an area in the image, the area being a part of the image and having a far-side borderline as a boundary thereof, the far-side borderline being a virtual line that is ahead of the vehicle by a distance;
an estimating unit that estimates the road parameters using a Kalman filter, based on the edge points extracted by the edge point extracting unit and positioned in the area set by the area setting unit; and
a vehicle speed acquiring unit that acquires a vehicle speed of the vehicle, wherein
the area setting unit increases the distance from the vehicle to the far-side borderline of the area in the image, as the vehicle speed acquired by the vehicle speed acquiring unit increases.

2. The road parameter estimation apparatus according to claim 1, wherein:
the area setting unit increases the distance in proportion to the vehicle speed acquired by the vehicle speed acquiring unit.

3. The road parameter estimation apparatus according to claim 2, further comprising:
an event determining unit that determines whether or not an event that makes extraction of the edge points difficult is present in at least a part of the area; and
a notifying unit that gives notification when the event determining unit determines that the event is present.

4. The road parameter estimation apparatus according to claim 3, wherein:
the event is one or more events selected from a group composed of a presence of a preceding vehicle, backlight, and a blurred lane boundary line.

5. The road parameter estimation apparatus according to claim 4, wherein:
the road parameter is one or more parameters selected from a group composed of a position of a lane boundary line, a tilt of the lane boundary line in relation to a front-rear direction of the vehicle, a curvature of the lane boundary line, a lane width, a rate of change of the curvature, and an amount of pitch.

6. The road parameter estimation apparatus according to claim 1, further comprising:
an event determining unit that determines whether or not an event that makes extraction of the edge points difficult is present in at least a part of the area; and
a notifying unit that gives notification when the event determining unit determines that the event is present.

7. The road parameter estimation apparatus according to claim 1, wherein:
the road parameter is one or more parameters selected from a group composed of a position of a lane boundary line, a tilt of the lane boundary line in relation to a front-rear direction of the vehicle, a curvature of the lane boundary line, a lane width, a rate of change of the curvature, and an amount of pitch.

8. An onboard system comprising:
an onboard network that is mounted to a vehicle:
a road parameter estimation apparatus that is connected to the onboard network and estimates road parameters; and
a control unit that is connected to the onboard network and acquires the road parameters from the road parameter estimation apparatus through the onboard network, thereby performing driving assistance using the road parameters,
the road parameter estimation apparatus comprising:
an image acquiring unit that acquires an image that shows an area ahead of the vehicle;
an edge point extracting unit that extracts edge points in the image;
an area setting unit that sets an area in the image, the area being a part of the image and having a far-side borderline as a boundary thereof, the far-side borderline being a virtual line that is ahead of the vehicle by a distance;
an estimating unit that estimates the road parameters using a Kalman filter, based on the edge points extracted by the edge point extracting unit and positioned in the area set by the area setting unit; and
a vehicle speed acquiring unit that acquires a vehicle speed of the vehicle, wherein
the area setting unit increases the distance from the vehicle to the far-side borderline of the area in the image, as the vehicle speed acquired by the vehicle speed acquiring unit increases.

9. A road parameter estimation method comprising:
acquiring an image that shows an area ahead of a vehicle;
extracting edge points in the image;
setting an area in the image, the area being a part of the image and having a far-side borderline as a boundary thereof, the far-side borderline being a virtual line that is ahead of the vehicle by a distance;
estimating the road parameters using a Kalman filter, based on the extracted edge points positioned in the set area;
acquiring a vehicle speed of the vehicle; and
increasing the distance from the vehicle to the far-side borderline of the area in the image, as the acquired vehicle speed increases.
